(19) United States
(12) Patent Application Publication
(10) Pub. No.: US 2010/0249322 A1
(43) Pub. Date: Sep. 30, 2010

(54) FLUORINATED SULFONIC ACID POLYMER GRAFTED POLYANILINE CONTAINING INTERMEDIATE TRANSFER MEMBERS

(75) Inventor: Jin Wu, Webster, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: XEROX CORPORATION, Norwalk, CT (US)

(21) Appl. No.: 12/413,633

(22) Filed: Mar. 30, 2009

(51) Int. Cl. C08L 51/08; C08L 67/00; C08G 69/48; C08F 283/00; C08L 81/00

(52) U.S. Cl. 525/63; 525/535; 525/420; 525/461; 525/418

(57) ABSTRACT

An intermediate transfer media, such as a belt, that includes a perfluorosulfonic acid/polytetrafluoroethylene polymer with the polymer being chemically bonded to or attached to a polyaniline.

### CROSS REFERENCE TO RELATED APPLICATIONS

Copending U.S. application No. (not yet assigned—Attorney Docket No. 20081114-US-NP) filed concurrently herewith, entitled Resin Mixture Backing Layer Containing Photoconductor, the disclosure of which is totally incorporated herein by reference, illustrates a photoconductor comprising a substrate, an imaging layer thereon, and a backing layer located on a side of the substrate opposite the imaging layer wherein the outermost layer of the backing layer adjacent to the substrate is comprised of a glycoluril resin, and a polyol resin mixture.

Copending U.S. application No. (not yet assigned—Attorney Docket No. 20081273-US-NP) filed concurrently herewith, entitled Perfluoropolyether Polymer Grafted Polyaniline Containing Intermediate Transfer Members, the disclosure of which is totally incorporated herein by reference, illustrates an intermediate transfer member comprised of a substrate and in contact with the substrate a polyaniline grafted perfluoropolyether phosphoric acid polymer.

Copending U.S. application No. (not yet assigned—Attorney Docket No. 20081274-US-NP) filed concurrently herewith, entitled Fluorotelomer Grafted Polyaniline Containing Intermediate Transfer Members, the disclosure of which is totally incorporated herein by reference, illustrates An intermediate transfer member comprised of a substrate, and a layer comprised of polyaniline having grafted thereto a fluorotelomer.

Copending U.S. application No. (not yet assigned—Attorney Docket No. 20081432-US-NP) filed concurrently herewith, entitled Layered Intermediate Transfer Members, the disclosure of which is totally incorporated herein by reference, illustrates an intermediate transfer member comprised of a polyimide substrate, and thereover a polyetherimide/polysiloxane.

Copending U.S. application No. (not yet assigned—Attorney Docket No. 20081433-US-NP) filed concurrently herewith, entitled Polyimide Polysiloxane Intermediate Transfer Members, the disclosure of which is totally incorporated herein by reference, illustrates an intermediate transfer member comprised of at least one of a polyimide/polyetherimide/polysiloxane, and a polyimide polysiloxane.

Copending U.S. application No. (not yet assigned—Attorney Docket No. 20081579-US-NP) filed concurrently herewith, entitled Glycoluril Resin And Polyol Resin Members, the disclosure of which is totally incorporated herein by reference, illustrates a process which comprises providing a flexible belt having at least one welded seam extending from one parallel edge to the other parallel edge, the welded seam having a rough seam region comprising an overlap of two opposite edges; contacting the rough seam region with a heat and pressure applying tool; and smoothing out the rough seam region with heat and pressure applied by the heat and pressure applying tool to produce a flexible belt having a smooth welded seam, and subsequently coating the seam with a resin mixture of a glycoluril resin and a polyol resin.

Copending U.S. application No. (not yet assigned—Attorney Docket No. 20081580-US-NP) filed concurrently herewith, entitled Glycoluril Resin And Polyol Resin Dual Members, the disclosure of which is totally incorporated herein by reference, illustrates a process which comprises providing a flexible belt having at least one welded seam extending from one parallel edge to the other parallel edge of the coating, the welded seam having a rough seam region comprising an overlap of two opposite edges; contacting the rough seam region with a heat and pressure applying tool; and smoothing out the rough seam region with heat and pressure applied by the heat and pressure applying tool, and subsequently coating the belt with a resin mixture of a glycoluril resin and a polyol resin.

Copending U.S. application No. (not yet assigned—Attorney Docket No. 20081612-US-NP) filed concurrently herewith, entitled Polyaniline Dialkylsulfate Complexes Containing Intermediate Transfer Members, the disclosure of which is totally incorporated herein by reference, illustrates an intermediate transfer member comprised of a polyaniline dialkylsulfate complex.

Copending U.S. application No. (not yet assigned—Attorney Docket No. 20081831-US-NP) filed concurrently herewith, entitled Crosslinked Resin Mixture Backing Layer Containing Photoconductor, the disclosure of which is totally incorporated herein by reference, illustrates a photoconductor comprising a substrate, an imaging layer thereon, and a backing layer located on a side of the substrate opposite the imaging layer wherein the outermost layer of the backing layer adjacent to the substrate is comprised of a mixture of glycoluril resin and a polyacetal resin mixture.

Illustrated in U.S. application Ser. No. 12/200,074 (Attorney Docket No. 20080579-US-NP) entitled Hydrophobic Carbon Black Intermediate Transfer Components, filed Aug. 28, 2008, the disclosure of which is totally incorporated herein by reference, is an intermediate transfer member comprised of a substrate comprising a carbon black surface treated with a poly(fluoroalkyl acrylate).

Illustrated in U.S. application Ser. No. 12/200,111 (Attorney Docket No. 20080580-US-NP) entitled Hydrophobic Polyetherimide/Polysiloxane Copolymer Intermediate Transfer Components, filed Aug. 28, 2008, is an intermediate transfer member comprised of a substrate comprising a polyetherimide polysiloxane copolymer.

Illustrated in U.S. application Ser. No. 12/200,147 (Attorney Docket No. 20080670-US-NP) entitled Coated Seamed Transfer Member, filed Aug. 28, 2008, is a process which comprises providing a flexible belt having a welded seam extending from one parallel edge to the other parallel edge, the welded seam having a rough seam region comprising an overlap of two opposite edges; contacting the rough seam region with a heat and pressure applying tool; and smoothing out the rough seam region with heat and pressure applied by the heat and pressure applying tool to produce a flexible belt having a smooth welded seam, and subsequently coating the seam with a crosslinked acrylic resin.

Illustrated in U.S. application Ser. No. 12/200,179 (Attorney Docket No. 20080671-US-NP) entitled Coated Transfer Member, filed Aug. 28, 2008, is a process which comprises providing a flexible belt having a welded seam extending from one parallel edge to the other parallel edge, the welded seam having a rough seam region comprising an overlap of two opposite edges; contacting the rough seam region with a heat and pressure applying tool; and smoothing out the rough seam region with heat and pressure applied by the heat and pressure applying tool to produce a flexible belt having a smooth welded seam, and subsequently coating the belt with a crosslinked acrylic resin.

Illustrated in U.S. application Ser. No. 12/129,995, filed May 30, 2008, entitled Polyimide Intermediate Transfer Components, the disclosure of which is totally incorporated herein by reference, is an intermediate transfer belt comprised of a substrate comprising a polyimide and a conductive component wherein the polyimide is cured at a temperature of for example, from about 175° C. to about 290° C. over a period of time of from about 10 minutes to about 120 minutes.

Illustrated in U.S. application Ser. No. 12/181,354, filed Jul. 29, 2008, entitled Core Shell Intermediate Transfer Components, the disclosure of which is totally incorporated herein by reference, is an intermediate transfer belt comprised of a substrate comprising a conductive core shell component.

Illustrated in U.S. application Ser. No. 12/181,409, filed Jul. 29, 2008, entitled Treated Carbon Black Intermediate Transfer Components, the disclosure of which is totally incorporated herein by reference, is an intermediate transfer members comprised of a substrate comprising a poly(vinylalkoxysilane) surface treated carbon black.

### BACKGROUND

Disclosed are intermediate transfer members, and more specifically, intermediate transfer members useful in transferring a developed image in an electrostatographic, for example xerographic, including digital, image on image, and the like, machines or apparatuses and printers. In embodiments, there are selected intermediate transfer members comprised of a fluorinated sulfonic acid polymer grafted polyaniline (PANI), such as a perfluorosulfonic acid/polytetrafluoroethylene copolymer grafted polyaniline, and more specifically, where a perfluorosulfonic acid/polytetrafluoroethylene copolymer is attached or grafted to a polyaniline surface by, for example, an in situ process. The polyaniline, in embodiments, is hydrophilic or substantially hydrophilic, and is also conductive. Furthermore, disclosed herein is a hydrophobic intermediate transfer member comprised of a hydrophobic polyaniline conductive component where the hydrophobic polyaniline component is in situ formed with a perfluorosulfonic acid/PTFE copolymer-grafted polyaniline.

In embodiments of this disclosure, there is provided an intermediate transfer member, such as an intermediate belt (ITB); a hydrophobic intermediate transfer member comprised of a hydrophobic polyaniline conductive component where the hydrophobic polyaniline component is an in situ formed perfluorosulfonic acid/PTFE copolymer-grafted polyaniline, and more specifically, where by a strong ionic interaction or acid doping, a perfluorosulfonic acid/PTFE copolymer (NAFION®) was in situ attached onto a polyaniline surface during milling of the ITB coating dispersion comprising polyaniline, NAFION®, and polymer such as a polyimide, a polycarbonate, a polyamidimide, a polyphenylene sulfide, a polyamide, a polysulfone, a polyetherimide, a polyester such as polybutylene terephthalate (PBT) or polyester copolymer, polyvinylidene fluoride (PVDF), polyethylene-co-polytetrafluoroethylene, and mixtures thereof in organic solvents.

The ITB member comprised of the disclosed hydrophobic NAFION®-grafted polyaniline (NAFION®-g-PANI) is, for example, hydrophobic, such as about 15 percent more hydrophobic as determined by an about 150 higher contact angle as compared to an ITB that contains the ungrafted polyaniline disclosed herein. Additionally, the perfluorosulfonic acid/PTFE copolymer functions as a fluorinated agent to increase the hydrophobicity of the ITB, and also acts as a strong acid dopant to render an increase or maintain the conductive characteristics of the ITB. In addition, primarily because of the ITB water repelling properties determined, for example, by accelerated aging experiments at 80° F./80 percent humidity for four weeks, the surface resistivity of the disclosed hydrophobic ITB member remained unchanged, while that of the controlled ITB member decreased to about ⅙ of the original value.

A number of advantages are associated with the intermediate transfer members, such as belts (ITB) of the present disclosure, such as an excellent maintained conductivity or resistivity for extended time periods; dimensional stability; ITB humidity insensitivity for extended time periods; excellent dispersability in a polymeric solution; low and acceptable surface friction characteristics; and high fidelity transfer.

In a typical electrostatographic reproducing apparatus, a light image of an original to be copied is recorded in the form of an electrostatic latent image upon a photosensitive member, and the latent image is subsequently rendered visible by the application of electroscopic thermoplastic resin particles and colorant. Generally, the electrostatic latent image is developed by contacting it with a developer mixture comprised of a dry developer mixture, which usually comprises carrier granules having toner particles adhering triboelectrically thereto, or a liquid developer material, which may include a liquid carrier having toner particles dispersed therein. The developer material is advanced into contact with the electrostatic latent image, and the toner particles are deposited thereon in image configuration. Subsequently, the developed image is transferred to a copy sheet. It is advantageous to transfer the developed image to a coated intermediate transfer web, belt or component, and subsequently transfer with a high transfer efficiency the developed image from the intermediate transfer member to a permanent substrate. The toner image is subsequently usually fixed or fused upon a support, which may be the photosensitive member itself, or other support sheet such as plain paper.

In electrostatographic printing machines wherein the toner image is electrostatically transferred by a potential difference between the imaging member and the intermediate transfer member, the transfer of the toner particles to the intermediate transfer member, and the retention thereof should be substantially complete so that the image ultimately transferred to the image receiving substrate will have a high resolution. Substantially about 100 percent toner transfer occurs when most or all of the toner particles comprising the image are transferred, and little residual toner remains on the surface from which the image was transferred.

Intermediate transfer members possess a number of advantages, such as enabling high throughput at modest process speeds; improving registration of the final color toner image in color systems using synchronous development of one or more component colors and using one or more transfer stations; and increasing the number of substrates that can be selected. However, a disadvantage of using an intermediate transfer member is that a plurality of transfer operations is usually needed allowing for the possibility of charge exchange occurring between toner particles and the transfer member which ultimately can lead to less than complete toner transfer, resulting in low resolution images on the image receiving substrate, and image deterioration. When the image is in color, the image can additionally suffer from color shifting and color deterioration.

Attempts at controlling the resistivity of intermediate transfer members by, for example, adding conductive fillers, such as ionic additives and/or carbon black to the outer layer, are disclosed in U.S. Pat. No. 6,397,034 which describes the use of fluorinated carbon filler in a polyimide intermediate transfer member layer. However, there can be problems associated with the use of such fillers in that undissolved particles frequently bloom or migrate to the surface of the fluorinated polymer and cause imperfections to the polymer, thereby causing nonuniform resistivity, which in turn causes poor antistatic properties and poor mechanical strength characteristics. Also, ionic additives on the ITB surface may interfere with toner release. Furthermore, bubbles may appear in the polymer, some of which can only be seen with the aid of a microscope, and others of which are large enough to be observed with the naked eye resulting in poor or nonuniform electrical properties and poor mechanical properties.

In addition, the ionic additives themselves are sensitive to changes in temperature, humidity, and operating time. These sensitivities often limit the resistivity range. For example, the resistivity usually decreases by up to two orders of magnitude or more as the humidity increases from about 20 percent to 80 percent relative humidity. This effect limits the operational or process latitude.

Moreover, ion transfer can also occur in these systems. The transfer of ions leads to charge exchanges and insufficient transfers, which in turn causes low image resolution and image deterioration, thereby adversely affecting the copy quality. In color systems, additional adverse results include color shifting and color deterioration. Ion transfer also increases the resistivity of the polymer member after repetitive use. This can limit the process and operational latitude, and eventually the ion filled polymer member will be unusable.

Therefore, it is desired to provide an intermediate transfer member, which has excellent hydrophobic and transfer capabilities; is conductive, and more specifically, has improved conductivity as compared, for example, to an intermediate transfer member where the grafted polymer illustrated herein is absent; and which disclosed transfer member, in embodiments, possesses excellent humidity insensitivity characteristics leading to high copy quality where developed images with minimal resolution issues can obtained. It is also desired to provide a weldable intermediate transfer belt that may not, but could have puzzle cut seams, and instead has a weldable seam, thereby providing a belt that can be manufactured without labor intensive steps, such as manually piecing together the puzzle cut seam with fingers, and without the lengthy high temperature and high humidity conditioning steps.

A number of the known ITB formulations apply carbon black or polyaniline as the conductive species; however, this has some limitations. For example, polyaniline is readily oxidized and results in loss of conductivity; its thermal stability is usually limited to about 200° C., and it begins to lose its conductivity at above 200° C. Also, it can be difficult to prepare carbon black based ITBs with consistent resistivity because the required loadings reside on the vertical part of the percolation curve. The amount of carbon black, and how carbon black is processed (primary particle size and aggregate size) are of value for conductivity and for the manufacturing of intermediate belts.

### REFERENCES

Illustrated in U.S. Pat. No. 7,031,647 is an imageable seamed belt containing a lignin sulfonic acid doped polyaniline.

Illustrated in U.S. Pat. No. 7,139,519 is an intermediate transfer belt, comprising a belt substrate comprising primarily at least one polyimide polymer; and a welded seam.

Illustrated in U.S. Pat. No. 7,130,569 is a weldable intermediate transfer belt comprising a substrate comprising a homogeneous composition comprising a polyaniline in an amount of, for example, from about 2 to about 25 percent by weight of total solids, and a thermoplastic polyimide present in an amount of from about 75 to about 98 percent by weight of total solids, wherein the polyaniline has a particle size of, for example, from about 0.5 to about 5 microns.

Puzzle cut seam members are disclosed in U.S. Pat. Nos. 5,487,707; 6,318,223, and 6,440,515.

Illustrated in U.S. Pat. No. 6,602,156 is a polyaniline filled polyimide puzzle cut seamed belt, however, the manufacture of a puzzle cut seamed belt is labor intensive and costly, and the puzzle cut seam, in embodiments, is sometimes weak. The manufacturing process for a puzzle cut seamed belt usually involves a lengthy in time high temperature and high humidity conditioning step. For the conditioning step, each individual belt is rough cut, rolled up, and placed in a conditioning chamber that is environmentally controlled at about 45° C. and about 85 percent relative humidity, for approximately 20 hours. To prevent or minimize condensation and watermarks, the puzzle cut seamed transfer belt resulting is permitted to remain in the conditioning chamber for a suitable period of time, such as 3 hours. The conditioning of the transfer belt renders it difficult to automate the manufacturing thereof, and the absence of such conditioning may adversely impact the belts electrical properties, which in turn results in poor image quality.

### SUMMARY

In embodiments, there is disclosed an apparatus for forming images on a recording medium comprising a charge retentive surface to receive an electrostatic latent image thereon; a development component to apply toner to the charge retentive surface, such as a photoconductor, to develop the electrostatic latent image, and to form a developed image on the charge retentive surface; and an intermediate transfer media that functions to transfer the developed image from the charge retentive surface to a substrate, wherein the intermediate transfer media is comprised of a substrate comprising perfluorosulfonic acid/polytetrafluoroethylene copolymer wherein the copolymer has chemically bonded thereto a polyaniline; an intermediate transfer member comprised of a substrate and in contact therewith a polyaniline having grafted thereto a fluorinated sulfonic acid polymer; a transfer media comprised of a polyaniline chemically bonded to a perfluorosulfonic acid/polytetrafluoroethylene copolymer; a transfer media, such as an intermediate transfer member comprised of a perfluorosulfonic acid/polytetrafluoroethylene copolymer chemically grafted to or attached to a polyaniline; an intermediate transfer member, such as an intermediate belt comprised of a substrate comprising an in situ attached perfluorosulfonic acid/PTFE copolymer attached to a polyaniline by, for example, an in situ process; an intermediate transfer member wherein the resisitivity thereof is from about 10⁶ to about 10¹³ ohm/sq, from about 10⁸ to about 10¹² ohm/sq, and more specifically, from about 10⁹ to about 10¹¹ ohm/sq, and is one order of magnitude lower than that of an intermediate belt comprised of a substrate comprising a polyaniline; an intermediate transfer member where the grafted polymer possesses a weight average molecular weight of from about 50,000 to about 5,000,000, a weight average molecular weight of from about 100,000 to about 1,000,000; a weight average molecular weight of from about 150,000 to about 300,000; and a number average molecular weight of from about 10,000 to about 1,000,000, of from about 20,000 to about 200,000, or from about 150,000 to about 250,000.

In embodiments, there is disclosed an intermediate transfer member comprised of a substrate comprising a perfluorosulfonic acid/PTFE copolymer grafted to or chemically bonded to a polyaniline with an excellent maintained resistivity for extended time periods. More specifically, there is almost no change in the intermediate transfer member disclosed herein surface resistivity, and where when it is aged in A zone (80° F./80 percent humidity) for two months, in comparison and under the same conditions, to about one order of magnitude decrease in surface resistivity for an intermediate transfer member comprised of a substrate comprising a polyaniline.

In addition, the present disclosure provides, in embodiments, an apparatus for forming images on a recording medium comprising a charge retentive surface to receive an electrostatic latent image thereon; a development component to apply toner to the charge retentive surface to develop the electrostatic latent image, and to form a developed image on the charge retentive surface; a weldable intermediate transfer belt to transfer the developed image from the charge retentive surface to a substrate, and a fixing component.

### FLUORINATED SULFONIC ACID POLYMER EXAMPLES

A number of fluorinated sulfonic acid (FSA) polymers can be selected for grafting to the polyaniline. The fluorinated sulfonic acid polymer includes, for example, fluorine atoms of at least about 50 percent of the total number of halogen and hydrogen atoms in the polymer, and in one embodiment at least about 75 percent, and in another embodiment at least about 90 percent. In another embodiment, the polymer is perfluorinated. The fluorinated sulfonic acid polymer comprises either sulfonic acid groups or salts of sulfonic acid groups, and in one embodiment alkali metal or ammonium salts. The functional group is represented by the formula —SO₃X where X is a cation, also known as a “counterion”. X may be H, Li, Na, K, or N(R₁)(R₂)(R₃)(R₄), and R₁, R₂, R₃, and R₄ are the same or different, and are in one embodiment H, CH₃, or C₂H₅. In one embodiment, X is H, in which case the polymer is said to be in the “acid form”. X may also be multivalent, as represented by such ions as Ca²⁺, and Al³⁺. It is clear to the skilled artisan that in the case of multivalent counterions, represented generally as Mⁿ⁺, the number of sulfonate functional groups per counterion will be equal to the valence “n”.

In one embodiment, the FSA polymer comprises a polymer backbone with recurring side chains attached to the backbone, the side chains including cation exchange groups. Polymer examples include homopolymers or copolymers of two or more monomers. Copolymers selected are typically formed from a nonfunctional monomer, and a second monomer that includes a cation exchange group or its precursor, like for example, a sulfonyl fluoride group (—SO₂F), which can be subsequently hydrolyzed to a sulfonate functional group. For example, copolymers of a first fluorinated vinyl monomer together with a second fluorinated vinyl monomer having a sulfonyl fluoride group (—SO₂F) can be used. Examples of first monomers include tetrafluoroethylene (TFE), hexafluoropropylene, vinyl fluoride, vinylidine fluoride, trifluoroethylene, chlorotrifluoroethylene, perfluoro(alkyl vinyl ether), and mixtures thereof.

In one embodiment, at least one monomer can be selected comprised of fluorinated vinyl ethers with sulfonate functional groups or precursor groups. Monomer examples of value are ethylene, propylene, and R′—CH═CH₂, where R′ is a perfluorinated alkyl group of 1 to 10 carbon atoms, can be incorporated into these polymers if desired. The polymers may be of the type referred to herein as random copolymers, which is copolymers made by polymerization in which the relative concentrations of the comonomers are kept as constant as possible, so that the distribution of the monomer units along the polymer chain is in accordance with their relative concentrations and relative reactivities. Less random copolymers, generated by varying relative concentrations of monomers in the course of the polymerization, and block copolymers, such as those disclosed in European Patent Application No. 1026152A1, can be selected in embodiments.

In one embodiment, the FSA polymer for use in the present disclosure includes a highly fluorinated, including those that are perfluorinated, carbon backbone and side chains represented by the formula

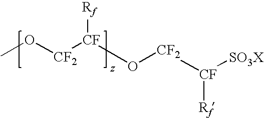

wherein R_{f} and R_{f}′ are independently selected from F, Cl, or a perfluorinated alkyl group having 1 to 10 carbon atoms; z is 0, 1 or 2; X is H, Li, Na, K, or N(R₁)(R₂)(R₃)(R₄); and R₁, R₂, R₃, and R₄ are the same or different, and in one embodiment are H, CH₃ or C₂H₅. In another embodiment X is H, and X may also be multivalent.

An example of a FSA polymer includes, for example, polymers disclosed in U.S. Pat. No. 3,282,875, and in U.S. Pat. Nos. 4,358,545 and 4,940,525. A specific example of a FSA polymer comprises a perfluorocarbon backbone, and the side chain represented by the formula

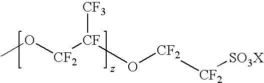

wherein X is as illustrated herein. FSA polymers of this type are disclosed in U.S. Pat. No. 3,282,875, and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanged as necessary to convert them to the desired ionic form. An example of a preferred polymer of the type disclosed in U.S. Pat. Nos. 4,358,545 and 4,940,525 has the side chain —O—CF₂CF₂SO₃X, wherein X is as defined above. This polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and further ion exchange as necessary.

The molecular weight of FSA polymer is uncertain due to differences in processing and solution morphology, and difficult to be determined using conventional methods such as light scattering and gel permeation chromatography. Instead, the equivalent weight (EW) is used to define the weight of the FSA polymer per mole of sulfonic acid group. Equivalent weight (EW) refers to, for example, the weight of the polymer in acid form required to neutralize one equivalent of sodium hydroxide. The FSA polymers suitable for this application possess an equivalent weight of from about 500 to about 2,000, or from about 750 to about 1,500.

The synthesis of FSA polymers is well known. The FSA polymers can be prepared as solutions and colloidal aqueous dispersions. They may also be in the form of dispersions in other media, examples of which include, but are not limited to, alcohol, water-soluble ethers, such as tetrahydrofuran, mixtures of water-soluble ethers, and combinations thereof. In preparing the dispersions, the polymer can be used in a number of differing known forms. U.S. Pat. Nos. 4,433,082; 6,150,426 and WO 03/006537 disclose methods for the preparation of aqueous alcoholic dispersions. After the dispersion is made, concentration and the dispersing liquid composition can be adjusted by methods known in the art.

A number of polymers can be selected for grafting to the polyaniline such as the in situ formed perfluorosulfonicacid/PTFE copolymer illustrated herein, which polymers and copolymers are readily available. For example, there can be selected as the grafter polymer NAFION®, a sulfonated tetrafluoroethylene copolymer available from E.I. DuPont Company, which copolymer represents a class of synthetic polymers with ionic properties referred to as ionomers. NAFION®'s ionic properties are believed to result from the incorporation of perfluorovinyl ether groups terminated with sulfonate groups onto a tetrafluoroethylene (TEFLON®) backbone as illustrated below

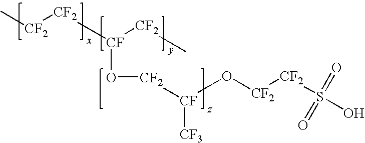

wherein z is, for example, about 0, 1 or 2; x is, for example, from about 1,000 to about 10,000, and y is, for example, from about 50 to about 2,000; and the equivalent weight of this FSA polymer is, for example, from about 500 to about 2,000, or from about 750 to about 1,500.

NAFION® is commercially available in many forms such as solutions, dispersions, pellets or membranes. An example of a solution selected for the ITB of the present disclosure is comprised of the NAFION® dissolved in a mixture of water and an alcohol, or alcohols or other solvents, which solutions are available from Ion Power, Inc., New Castle, Del. as LIQUION™; and more specifically, 5 weight percent of LIQUION™ NAFION® containing solution is comprised of 5 weight percent of NAFION® (with either an EW of 1,000 or an EW of 1,100), 20 weight percent of water and 75 weight percent of isopropanol; 15 weight percent of LIQUION™ NAFION® containing solution is comprised of 15 weight percent of NAFION® (with either an EW of 1,000 or an EW of 1,100), 45 weight percent of water, and 40 weight percent of isopropanol.

An example of a dispersion selected for the ITB of the present disclosure is comprised of the NAFION® dispersed in a mixture of water, and an alcohol or alcohols, or other solvents, which solutions are available from DuPont Fluoroproducts, Fayetteville, N.C. as DuPont™, and more specifically, DuPont™ NAFION® dispersion DE520/521 (5 weight percent of polymer, 45 weight percent of water, and 50 weight percent of 1-propanol, ethanol, and mixed ethers); DE1020/1021 (10 weight percent of polymer and 90 weight percent of water); DE2020/2021 (20 weight percent of polymer, 34 weight percent of water, and 46 weight percent of 1-propanol, ethanol and mixed ethers).

The in situ grafting of a perfluorosulfonic acid/PTFE copolymer (NAFION®) onto the polyaniline surface via the strong ionic interaction between the perfluorosulfonic acid of NAFION® and the imine of the polyaniline, as illustrated below renders the particles obtained hydrophobic.

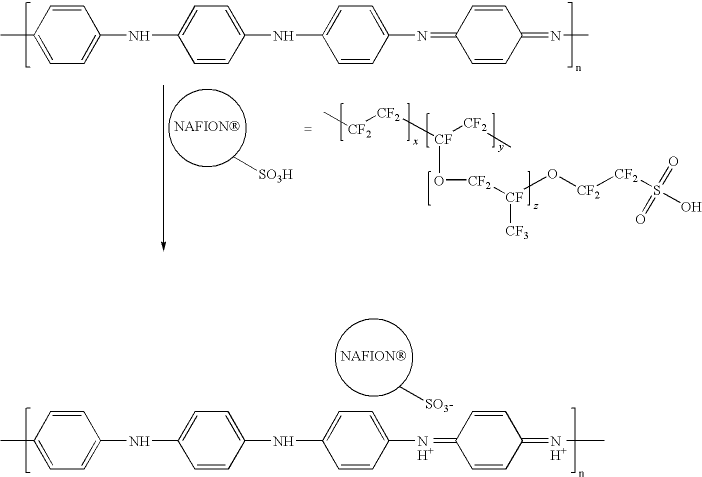

More specifically, an ITB coating dispersion is prepared by mixing or milling polyaniline, NAFION®, and polymer such as a polyimide, a polycarbonate, a polyamidimide, a polyphenylene sulfide, a polyamide, a polysulfone, a polyetherimide, a polyester, such as polybutylene terephthalate (PBT) or polyester copolymer, polyvinylidene fluoride (PVDF), polyethylene-co-polytetrafluoroethylene, and mixtures thereof, in organic solvents at ambient temperatures (about 20 to 25° C.) for about 8 to about 24 hours.

### OTHER ITB COMPONENT EXAMPLES

Examples of the polyaniline component selected for the intermediate transfer member is, for example, comprised of relatively small particles with a size diameter of, for example, from about 0.5 to about 5, from about 1.1 to about 2.3, from about 1.2 to about 2, from about 1.5 to about 1.9, or about 1.7 microns. Specific examples of polyanilines selected for the transfer member, such as an ITB, are PANIPOL™ F, commercially available from Panipol Oy, Finland.

Examples of additional components present in the intermediate transfer member include a number of known polymers and conductive components.

Examples of polymeric binders that, in embodiments, may be included in the intermediate transfer member are polyimides (thermosetting or thermoplastic), polycarbonate, poly(ethylene terephthalate) (PET), poly(ethylene naphthalate) (PEN), poly(butylene terephthalate) (PBT), polypolyvinylidene fluoride (PVDF), polyethylene-co-polytetrafluoroethylene, polyamidimide, polyphenylene sulfide, polyamide, polysulfone, polyetherimide, polyester copolymer, rapidly cured polyimide polymers such as VTEC™ PI 1388, 080-051, 851, 302, 203, 201, and PETI-5, all available from Richard Blaine International, Incorporated, Reading, Pa. The thermosetting polyimides are cured at suitable temperatures, and more specifically, from about 180° C. to about 260° C. over a short period of time, such as, for example, from about 10 to about 120 minutes, and from about 20 to about 60 minutes; possess, for example, a number average molecular weight of from about 5,000 to about 500,000, or from about 10,000 to about 100,000, and a weight average molecular weight of from about 50,000 to about 5,000,000, or from about 100,000 to about 1,000,000; thermosetting polyimide precursors that are cured at higher temperatures (above 300° C.) than the VTEC™ PI polyimide precursors, and which precursors include, for example, PYRE-M.L® RC-5019. RC-5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 10, commercially available from FUJIFILM Electronic Materials U.S.A., Inc., North Kingstown, R.I.; and KAPTON® HN, VN and FN, commercially available from E.I. DuPont, Wilmington, Del., in amounts of, for example, of from about 70 to about 97 weight percent, or from about 80 to about 95 weight percent of the intermediate transfer member.

Examples of specific selected thermoplastic polyimides are KAPTON® KJ, commercially available from E.I. DuPont, Wilmington, Del., as represented by

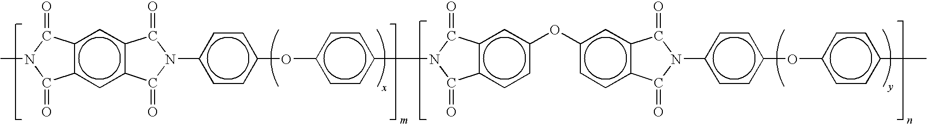

wherein x is equal to 2; y is equal to 2; m and n are from about 10 to about 300; and IMIDEX®, commercially available from West Lake Plastic Company, as represented by

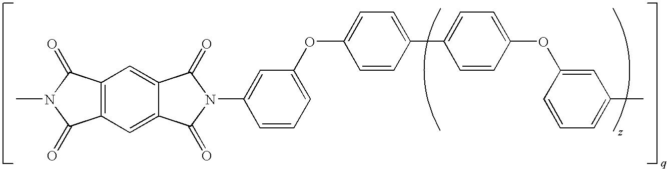

wherein z is equal to 1, and q is from about 10 to about 300.

Examples of polycarbonate binders selected include poly(4,4′-isopropylidene-diphenylene)carbonate (also referred to as bisphenol-A-polycarbonate), poly(4,4′-cyclohexylidine diphenylene)carbonate (also referred to as bisphenol-Z-polycarbonate), poly(4,4′-isopropylidene-3,3′-dimethyl-diphenyl)carbonate (also referred to as bisphenol-C-polycarbonate), and the like. In embodiments, the intermediate transfer member binders are comprised of bisphenol-A-polycarbonate resins, commercially available as MAKROLON®, with a weight average molecular weight of from about 50,000 to about 500,000.

The in situ formed FSA-grafted polyaniline is present in an amount of from about 3 to about 30 weight percent of the total weight of the ITB, and the polymeric binder is present in an amount of from about 80 to about 97 weight percent of the total weight of the ITB. Within the FSA-grafted polyaniline, the weight ratio of the FSA and the polyaniline is from about 1/99 to about 50/50, or from about 20/80 to about 40/60.

Examples of additional components present in the intermediate transfer member are a number of known conductive components present in an amount of from about 3 to about 20 weight percent such as a second polyaniline. In embodiments, the second polyaniline component has a relatively small particle size of, for example, from about 0.5 to about 5, from about 1.1 to about 2.3, from about 1.2 to about 2, from about 1.5 to about 1.9, or about 1.7 microns. Specific examples of the second polyanilines selected for the transfer member, such as an ITB, are PANIPOL™ F, commercially available from Panipol Oy, Finland.

For example, the perfluorosulfonic acid/polytetrafluoroethylene, and the polyaniline can be dispersed in a fast cure thermosetting polyimide/N-methyl-2-pyrrolidone (NMP) solution resulting in an in situ formed perfluorosulfonic acid/polytetrafluoroethylene grafted polyaniline dispersed in a polyimide, and then the dispersion can be applied to or coated on a glass plate using known draw bar coating methods. The resulting film or films can be dried at high temperatures, such as from about 100° C. to about 400° C., from about 150° C. to about 300° C., and from about 175° C. to about 200° C. for a sufficient period of time, such as for example, from about 20 to about 180 minutes, or from about 75 to about 100 minutes while remaining on the glass plate. After drying and cooling to room temperature, the film or films on the glass plate or separate glass plates are immersed into water overnight, about 18 to 23 hours, and subsequently, the 50 to 150 microns thick film of films formed are released from the glass resulting in the functional intermediate transfer member or members as disclosed herein.

In embodiments, the perfluorosulfonic acid/polytetrafluoroethylene and the polyaniline can be dispersed in a bisphenol-A-polycarbonate/copolyester of iso/terephthalic acid, dimethylpropanediol, and ethanediol/methylene chloride (CH₂Cl₂) solution resulting in an in situ formed perfluorosulfonic acid/polytetrafluoroethylene grafted polyaniline dispersed in a polycarbonate/copolyester blend, and then the dispersion can be applied to or coated on a biaxially oriented poly(ethylene naphthalate) (PEN) substrate (KALEDEX™ 2000) having a thickness of 3.5 mils using known draw bar coating methods. The resulting film or films can be dried at high temperatures, such as from about 100° C. to about 200° C., or from about 120° C. to about 160° C., for a sufficient period of time, such as for example, from about 1 to about 30 minutes, or from about 5 to about 15 minutes, while remaining on the PEN substrate. After drying and cooling to room temperature, about 23 to about 25° C., the film or films on the PEN substrate or separate PEN substrates are automatically released from the substrate resulting in the functional intermediate transfer member or members as disclosed herein.

The disclosed intermediate transfer members are, in embodiments, weldable, that is the seam of the member, like a belt is weldable, and more specifically, may be ultrasonically welded to produce a seam. The surface resistivity of the disclosed intermediate transfer member is, for example, from about 10⁹ to about 10¹³, or from about 10¹⁰ to about 10¹² ohm/sq. The sheet resistivity of the intermediate transfer weldable member is, for example, from about 10⁹ to about 10¹³, or from about 10¹⁰ to about 10¹² ohm/sq.

The intermediate transfer members, illustrated herein like intermediate transfer belts, can be selected for a number of printing, and copying systems, inclusive of xerographic printing. For example, the disclosed intermediate transfer members can be incorporated into a multi-imaging system where each image being transferred is formed on the imaging or photoconductive drum at an image forming station, wherein each of these images is then developed at a developing station, and transferred to the intermediate transfer member. The images may be formed on the photoconductor and developed sequentially, and then transferred to the intermediate transfer member. In an alternative method, each image may be formed on the photoconductor or photoreceptor drum, developed, and transferred in registration to the intermediate transfer member. In an embodiment, the multi-image system is a color copying system, wherein each color of an image being copied is formed on the photoreceptor drum, developed, and transferred to the intermediate transfer member.

After the toner latent image has been transferred from the photoreceptor drum to the intermediate transfer member, the intermediate transfer member may be contacted under heat and pressure with an image receiving substrate such as paper. The toner image on the intermediate transfer member is then transferred and fixed, in image configuration, to the substrate such as paper.

The intermediate transfer member present in the imaging systems illustrated herein, and other known imaging and printing systems, may be in the configuration of a sheet, a web, a belt, including an endless belt, an endless seamed flexible belt, and an endless seamed flexible belt; a roller, a film, a foil, a strip, a coil, a cylinder, a drum, an endless strip, and a circular disc. The intermediate transfer member can be comprised of a single layer, or it can be comprised of several layers, such as from about 2 to about 5 layers. In embodiments, the intermediate transfer member further includes an outer release layer.

Release layer examples include low surface energy materials such as TEFLON®-like materials including fluorinated ethylene propylene copolymer (FEP), polytetrafluoroethylene (PTFE), polyfluoroalkoxy polytetrafluoroethylene (PFA TEFLON®) and other TEFLON®-like materials; silicone materials such as fluorosilicones and silicone rubbers such as Silicone Rubber 552, available from Sampson Coatings, Richmond, Va., (polydimethyl siloxane/dibutyl tin diacetate, 0.45 g DBTDA per 100 grams polydimethyl siloxane rubber mixture, with molecular weight of approximately 3,500); and fluoroelastomers such as those sold under the tradename VITON® such as copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50, VITON E45®, and VITON GF®. The VITON® designation is a Trademark of E.I. DuPont de Nemours, Inc. Two preferred known fluoroelastomers are (1) a class of copolymers of vinylidenefluoride, hexafluoropropylene, and tetrafluoroethylene, known commercially as VITON A®, (2) a class of terpolymers of vinylidenefluoride, hexafluoropropylene, and tetrafluoroethylene known commercially as VITON B®, and (3) a class of tetrapolymers of vinylidenefluoride, hexafluoropropylene, tetrafluoroethylene, and a cure site monomer such as VITON GF® having 35 mole percent of vinylidenefluoride, 34 mole percent of hexafluoropropylene, and 29 mole percent of tetrafluoroethylene with 2 percent cure site monomer. The cure site monomer can be those available from DuPont such as 4-bromoperfluorobutene-1,1,1-dihydro-4-bromoperfluorobutene-1,3-bromoperfluoropropene-1,1,1-dihydro-3-bromoperfluoropropene-1, or any other suitable, known, commercially available cure site monomer.

The circumference of the intermediate transfer member, especially as it is applicable to a film or a belt configuration, is, for example, from about 250 to about 2,500 millimeters, from about 1,500 to about 2,500 millimeters, or from about 2,000 to about 2,200 millimeters with a corresponding width of, for example, from about 100 to about 1,000 millimeters, from about 200 to about 500 millimeters, or from about 300 to about 400 millimeters.

Specific embodiments will now be described in detail. These examples are intended to be illustrative, and the disclosure is not limited to the materials, conditions, or process parameters set forth in these embodiments. All parts are percentages by weight of total solids unless otherwise indicated.

### COMPARATIVE EXAMPLE 1

An intermediate transfer belt (ITB) member comprised of the controlled polyaniline (PANI) was prepared as follows.

One gram of PANIPOL® F, an emeraldine salt obtained from Panipol Oy (Porvoo Finland), was mixed with 8 grams of MAKROLON® 5705, a known polycarbonate resin having a M_{w} molecular weight average of from about 50,000 to about 100,000, commercially available from Farbenfabriken Bayer A.G., 1 gram of VITEL® 2200, a copolyester of iso/terephthalic acid, dimethylpropanediol, and ethanediol having a melting point of from about 302° C. to about 320° C. (degrees Centigrade), commercially available from Shell Oil Company, Houston, Tex., and 100 grams of methylene chloride. By ball milling this mixture with 2 millimeter stainless shot overnight, or 23 hours, a uniform dispersion was obtained.

The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate resulting in a 20 micron thick intermediate transfer member of polyaniline/polycarbonate/copolyester with a ratio by weight of 10/80/10.

### EXAMPLE I

An intermediate transfer belt (ITB) member comprised of the disclosed hydrophobic NAFION®-grafted polyaniline (NAFION®-g-PANI) was prepared as follows.

0.67 Gram of PANIPOL® F, an emeraldine salt obtained from Panipol Oy (Porvoo Finland), was mixed with 8 grams of MAKROLON® 5705, a known polycarbonate resin having a M_{w} molecular weight average of from about 50,000 to about 100,000, commercially available from Farbenfabriken Bayer A.G., 1 gram of VITEL® 2200, a copolyester of iso/terephthalic acid, dimethylpropanediol, and ethanediol having a melting point of from about 302° C. to about 320° C. (degrees Centigrade), commercially available from Shell Oil Company, Houston, Tex., 2.2 grams of 15 weight percent of LIQUION™ NAFION® containing solution (15 weight percent of NAFION® with an EW of 1,100, 45 weight percent of water, and 40 weight percent of isopropanol), available from Ion Power, Inc., New Castle, Del., and 100 grams of methylene chloride. By ball milling this mixture with 2 millimeter stainless shot overnight, or 23 hours, a uniform dispersion was obtained. During this process, it is believed that the NAFION® polymer is chemically bonded to the polyaniline surface in situ, rendering it more hydrophobic and more conductive, as referenced by the following contact angles and resistivity measurements.

The dispersion was then coated on a biaxially oriented poly(ethylene naphthalate) (PEN) substrate (KALEDEX™2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate resulting in a 20 micron thick intermediate transfer member of NAFION®-g-polyaniline/polycarbonate/copolyester with a ratio by weight of 10/80/10.

### Surface Resistivity Measurement

The above ITB members or devices of Comparative Example 1, and Example I were measured after one day for surface resistivity (averaging four to six measurements at varying spots, 72° F./65 percent room humidity) using a High Resistivity Meter (Hiresta-Up MCP-HT450 from Mitsubishi Chemical Corp.). Then the ITB devices were acclimated in A zone (80° F./80 percent humidity) for an aging study, and the surface resistivity was measured again at 1 month and 2 months. The results are provided in Table 1.

TABLE 1

| | | | Surface |
|---|---|---|---|
| | | | Resistivity |
| | Surface | Surface | After 2 |
| | Resistivity After 1 | Resistivity After 1 | Months |
| | Day (ohm/sq) | Month (ohm/sq) | (ohm/sq) |
| Comparative | (2.78 ± 0.09) × 10⁹ | (4.35 ± 0.24) × 10⁸ | (2.63 ± 0.13) × |
| Example 1 | | | 10⁸ |
| Example I | (1.44 ± 0.05) × 10⁸ | (1.45 ± 0.06) × 10⁸ | (1.39 ± 0.11) × |
| | | | 10⁸ |

The disclosed fresh ITB device (Example I with no aging history) comprised of the disclosed NAFION®-g-polyaniline dispersed in the polycarbonate/copolyester blend exhibited about one twentieth surface resistivity when compared with the controlled device comprised of the controlled polyaniline dispersed in the polycarbonate/copolyester blend (Comparative Example 1 with no aging history), indicating that the disclosed NAFION®-g-polyaniline was intrinsically more conductive than the controlled polyaniline due to extra acid doping from the FSA polymer.

After 2 month aging in A zone, a stressful environment for ITB aging, the surface resistivity of the disclosed ITB device (Example I with 2 month aging in A zone) remained unchanged, while that of the polyaniline ITB device of Comparative Example 1 with 2 month aging in A zone decreased to about one tenth of the original value. The disclosed ITB device not only exhibited lower resistivity at the beginning, but remained electrically stable with accelerated aging with almost no change in surface resistivity due to the water repelling of the hydrophobic NAFION®-g-polyaniline.

### Contact Angle Measurement

The advancing contact angles of water (in deionized water) on the ITB devices of Comparative Example 1 and Example I were measured at ambient temperature (about 23° C.), using the Contact Angle System OCA (Dataphysics Instruments GmbH, model OCAL5. At least ten measurements were performed, and their averages are reported in Table 2.

TABLE 2

| | Contact Angle |
|---|---|
| Comparative Example 1 | 45 Degrees |
| Example I | 60 Degrees |

The disclosed ITB device (Example I) with the NAFION®-grafted polyaniline was significantly more hydrophobic (about 15 degrees higher contact angle) than the Comparative Example 1 ITB device with the untreated polyaniline.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. An intermediate transfer member comprised of a substrate, and in contact therewith a polyaniline having grafted thereto a fluorinated sulfonic acid polymer.

2. An intermediate transfer member in accordance with claim 1 wherein said polyaniline has a particle size of from about 0.5 to about 5 microns.

3. An intermediate transfer member in accordance with claim 1 wherein said fluorinated sulfonic acid polymer is a copolymer of tetrafluoroethylene and perfluorovinyl ether as represented by 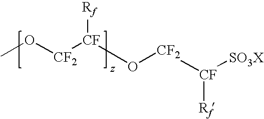
wherein R_{f} and R_{f}′ are independently selected from the group consisting of F, Cl, and a perfluorinated alkyl group containing from 1 to about 10 carbon atoms; z is 0, 1 or 2, and X is H, Li, Na, K, or N(R₁)(R₂)(R₃)(R₄), and R₁, R₂, R₃, and R₄ are independently selected from the group consisting of H, CH₃, and C₂H₅.

4. An intermediate transfer member in accordance with claim 1 wherein said fluorinated sulfonic acid polymer is represented by 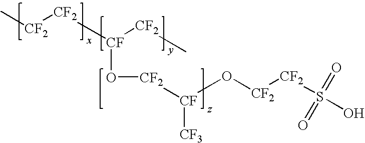
wherein z is 0, 1 and 2; x is from about 1,000 to about 10,000, and y is from about 50 to about 2,000.

5. An intermediate transfer member in accordance with claim 1 wherein said fluorinated sulfonic acid polymer possesses an equivalent weight of from about 500 to about 2,000, and wherein fluorine atoms comprise at least about 50 percent of the total number of halogen and hydrogen atoms in the polymer.

6. An intermediate transfer member in accordance with claim 1 wherein said fluorinated sulfonic acid polymer possesses an equivalent weight of from about 750 to about 1,500, and wherein fluorine atoms comprise at least about 90 percent of the total number of halogen and hydrogen atoms in the polymer.

7. An intermediate transfer member in accordance with claim 1 wherein said fluorinated sulfonic acid polymer grafted polyaniline is present in an amount of from about 3 to about 30 weight percent.

8. An intermediate transfer member in accordance with claim 1 wherein the ratio of said fluorinated sulfonic acid polymer to said polyaniline is from about 1/99 to about 50/50.

9. An intermediate transfer member in accordance with claim 1 wherein the ratio of said fluorinated sulfonic acid polymer to said polyaniline is from about 20/80 to about 40/60.

10. An intermediate transfer member in accordance with claim 1 wherein said fluorinated sulfonic acid polymer is present in an amount of from about 0.03 to about 15 percent by weight based on the weight of total solids.

11. An intermediate transfer member in accordance with claim 1 wherein said fluorinated sulfonic acid polymer is present in an amount of from about 0.6 to about 12 percent by weight based on the weight of total solids.

12. An intermediate transfer member in accordance with claim 1 wherein said member is a weldable belt.

13. An intermediate transfer member in accordance with claim 1 further including a second polyaniline present in an amount of from about 1 to about 30 percent by weight based on the weight of total solids.

14. An intermediate transfer member in accordance with claim 1 further including a polymer selected from the group consisting of a polyimide, a polycarbonate, a polyamidimide, a polyphenylene sulfide, a polyamide, a polysulfone, a polyetherimide, a polyester or polyester copolymer, a polyvinylidene fluoride, a polyethylene-co-polytetrafluoroethylene, and mixtures thereof, present in an amount of from about 70 to about 97 weight percent.

15. An intermediate transfer member in accordance with claim 1 wherein said member has a surface resistivity of from about 10⁷ to about 10¹³ ohm/sq.

16. An intermediate transfer member in accordance with claim 15 wherein said surface resistivity is from about 10⁹ to about 10¹² ohm/sq.

17. An intermediate transfer member in accordance with claim 1 further comprising an outer release layer positioned on said grafted polymer in the form of a layer.

18. An intermediate transfer member in accordance with claim 17 wherein said release layer comprises a poly(vinyl chloride), a fluorinated ethylene propylene copolymer, a polytetrafluoroethylene, a polyfluoroalkoxy polytetrafluoroethylene, a fluorosilicone, a polymer of vinylidenefluoride, hexafluoropropylene and tetrafluoroethylene, and the mixtures thereof.

19. A transfer media comprised of a perfluorosulfonic acid/polytetrafluoroethylene copolymer chemically grafted to a polyaniline.

20. A transfer media in accordance with claim 19 wherein said copolymer grafted polyaniline is mixed with a polymeric binder of a polyimide, a polycarbonate, a polyamidimide, a polyphenylene sulfide, a polyamide, a polysulfone, a polyetherimide, a polyester, a polyvinylidene fluoride, a polyethylene-co-polytetrafluoroethylene, or mixtures thereof.

21. A transfer media comprised of a polyaniline chemically bonded to a perfluorosulfonic acid/polytetrafluoroethylene copolymer.

22. A transfer media in accordance with claim 21 wherein said copolymer is generated in situ from a dispersion of said copolymer, said polyaniline, and a polymer in a solvent.

23. A transfer media in accordance with claim 22 wherein said polymer is selected from the group consisting of a polyimide, a polycarbonate, a polyamidimide, a polyphenylene sulfide, a polyamide, a polysulfone, a polyetherimide, a polyester or polyester copolymer, a polyvinylidene fluoride, a polyethylene-co-polytetrafluoroethylene, and mixtures thereof; and said solvent is selected from the group consisting of methylene chloride, water, alcohol, ether, ketone, ester, and an aromatic.

24. A transfer media in accordance with claim 22 wherein said alcohol is methanol, ethanol, 1-propanol, isopropanol, 1-buanol, 2-butanol or mixtures thereof present in an amount of from about 1 to about 90 weight percent, or from about 30 to about 75 weight percent; and wherein said water is present in an amount of from about 1 to about 99 weight percent or from about 20 to about 60 weight percent.

25. An intermediate transfer member in accordance with claim 1 wherein said polyaniline is hydrophobic and conductive, and which polyaniline is a poly(p-phenyleneimineamine).

26. An intermediate transfer member in accordance with claim 1 wherein said perfluorosulfonic acid polytetrafluoroethylene is a copolymer, and wherein said copolymer has chemically bonded thereto said polyaniline.

27. An intermediate transfer member in accordance with claim 26 wherein said polyaniline is a poly(p-phenyleneimineamine).

28. An intermediate transfer member in accordance with claim 26 wherein said polyaniline is a hydrochloride acid doped emeraldine base, a sulfonic acid doped emeraldine base, or a nitric acid doped emeraldine base each with a particle size of from about 0.5 to about 5 microns, or from about 1.1 to about 2.3 microns.

29. An intermediate transfer member in accordance with claim 1 wherein said grafted polymer possesses a weight average molecular weight of from about 50,000 to about 5,000,000, or possesses a weight average molecular weight of from about 100,000 to about 1,000,000; and a number average molecular weight of from about 10,000 to about 1,000,000.

30. An intermediate transfer member in accordance with claim 1 wherein said grafted polymer possesses a weight average molecular weight of from about 100,000 to about 500,000, and possesses a number average molecular weight of from about 20,000 to about 200,000.

31. An intermediate transfer member in accordance with claim 26 wherein said grafted polymer possesses a weight average molecular weight of form about 100,000 to about 500,000, and possesses a number average molecular weight of from about 20,000 to about 200,000.
